(19) United States
(12) Patent Application Publication
(10) Pub. No.: US 2008/0159092 A1
(43) Pub. Date: Jul. 3, 2008

(54) Medium storage device, position demodulation device and position demodulation method

(75) Inventors: Yoshiyuki Kagami, Kawasaki (JP); Tatsuhiko Kosugi, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/004,077

(22) Filed: Dec. 19, 2007

(30) Foreign Application Priority Data
Dec. 27, 2006 (JP) 2006-350813

(51) Int. Cl. G11B 7/00

(52) U.S. Cl. 369/44.26

(57) ABSTRACT

A first and second phase patterns of which phases are the same and a third and fourth phase patterns of which phases are opposite of the first and second phase patterns and of which phases are different from each other, are formed on a recording medium. A position information in a first track range is demodulated based on a first phase difference of the regeneration signals of the first and second phase pattern and of the third phase pattern, position information in a second track range is demodulated based on a second phase difference of the regeneration signals in the third phase pattern and the fourth phase pattern, and position information in a third track range is demodulated based on the first phase difference according to an angle difference between the first phase difference and a phase of the regeneration signal in the third phase pattern.

### CROSS-REFERENCE TO RELATED APPLICATIONS

This application is based upon and claims the benefit of priority from the prior Japanese Patent Application No. 2006-350813, filed on Dec. 27, 2006, the entire contents of which are incorporated herein by reference.

### BACKGROUND OF THE INVENTION

1. Field of the Invention

The present invention relates to a position demodulation method, position demodulation device and medium storage device for demodulating a servo pattern that a head reads from a storage medium and detecting a position of the head, and more particularly to a position demodulation method, position demodulation device and medium storage device for expanding a position demodulation range during seek control for the head.

2. Description of the Related Art

A disk device of which storage medium is a rotating body is widely used as a storage device connected to a host. In the disk device, a head is positioned on a track of a disk, and the head reads and writes the target data on the track. Therefore the position of the head on the disk must be detected.

As FIG. 10 shows, many tracks are formed on the magnetic disk 10 from the outer circumference to the inner circumference, and servo signals (position signals) 16 are positioned on each track in the circumference direction at an equal interval. Each track is constituted by a plurality of sectors, and the solid line in FIG. 10 indicates the recording positions of the servo signals 16.

As the read waveform of the magnetic head in FIG. 11 shows, a servo (position) signal is constituted by a servo mark SMK, gray code Gray Code, servo burst (Position Burst) signal and post code (Post Code).

The servo mark indicates the beginning of the servo signal, and shows that the signal after the servo mark is the servo signal. The gray code indicates a cylinder number. The post code indicates an eccentricity correction amount of the servo sector. The servo burst signal is used to detect the track position and a position in the track of the head.

The servo signal in FIG. 11 is read by the head, and the gray code and the servo burst signal are demodulated to detect the current position of the magnetic head in the radius direction. For this servo burst signal, the phase servo pattern signal shown at the bottom of FIG. 11 is used.

As FIG. 11 shows, the phase area has four phase patterns, and each phase is a pattern having a predetermined feed angle per track. In other words, EVEN1 has a feed angle (per track) +90°, ODD1 −90°, EVEN2 +90° and ODD2 −135°.

In the phase pattern of EVEN1, for example, the phase difference between a certain track and the adjacent track is +90°. Therefore EVEN1, EVEN2 and ODD1 all have a pattern where repeat continues in a 4 track (cylinder) unit.

Based on this phase pattern, ±1 cylinder demodulation and ±4 cylinder demodulation are possible by computing the following Expressions (1) and (2).

### [Expression 1]

(±1 cyl demodulation)=(EVEN1+EVEN2)/2−ODD1 (1)

### [Expression 2]

(±4 cyl demodulation)=ODD1−ODD2 (2)

For example, FIG. 12 is a graph depicting the change of the track position and the detection angle where the abscissa is the track position and the ordinate is the detection angles of EVEN1, EVEN2 and ODD1. In other words, as shown in the formula (1), EVEN1 and EVEN2 are added and averaged to perform ±1 cylinder demodulation, which is resistant to noise (particularly rotation fluctuation), so that demodulation accuracy is increased.

FIG. 13 is a graph depicting the change of the track position and the detection angle where the abscissa is the track position and the ordinate is the detection angles of ODD1 and ODD2. In other words, the demodulation range is expanded to that of the ±4 cylinder using a pattern having feeding angle −135° as ODD2.

By combining FIG. 12 and FIG. 13, the relationship between the track position, the detection angles of EVEN1, EVEN2, ODD1 and ODD2, ±1 demodulation (angle, track position) and ±4 demodulation (angle, track position) is acquired as shown in FIG. 14 (e.g. Japanese Patent No. 3,340,077).

As Expressions (1) and (2) show, in the prior art, the demodulation was performed using the relative differences of the angles of EVEN1, EVEN2, ODD1 and ODD2, and the current position is acquired. Therefore the demodulation range of the ±4 cylinder, at maximum, is acquired from the phase burst signal.

Recently high-speed and high precision seek control is demanded, and FF (Feed Forward) seek control is used for this. In the FF seek control, a target position from seek start is determined for each sample according to the seek distance, and the feed forward current corresponding to the difference of the target positions of these samples is output. According to the position error of the differential position between samples and the demodulated position, the feedback controller outputs the feedback current.

In other words, the feed forward current for the target trajectory is supplied for each sample, and the error with the target trajectory is acquired by the error between the difference of the samples on the target trajectory and the demodulated position, and is corrected by the feedback controller. If FF seek control is used, the drive amplifier can be used effectively, and seek time can be decreased.

However because of the temperature change and the power supply voltage fluctuation, the characteristic fluctuation of the drive amplifier or the actuator for moving the magnetic head and the wind disturbance of the suspension of the magnetic head due to caused by wind generated by the rotation of the magnetic head, tend to increase errors from the target trajectory.

In this case, in the conventional art, as the demodulation range is within a ±4 cylinder (that is, the position demodulation in 8 cylinder units), the position error from the target trajectory becomes high. Therefore the maximum value of the position error exceeds the demodulation range, and the possibility of a seek error increases. If a seek error occurs, seek retry, which performs the seek operation all over again, must be performed, and this increases the seek time.

Therefore expanding the demodulation range is required. For this method, a method for detecting the current position using both gray code, which indicates a cylinder number, and the demodulation result of the servo burst signals, has been conventionally used.

However in an area where the recording density in the circumference direction is low, such as an outer zone of a magnetic disk, the gray code can be demodulated relatively accurately, but in an area where the recording density in the circumference direction is high, such as an inner zone, the error rate of gray code is high, so the reliability of position detection by gray code is low.

Therefore in the case of the method of combined using the gray code, the demodulation range in the outer zone expands, but the demodulation range in the inner zone does not, and an improvement of the seek performance from the outer to inner zone cannot be expected. Also the demodulation processing must be changed between the outer zone and inner zone, which makes demodulation processing complicated.

### SUMMARY OF THE INVENTION

With the foregoing in view, it is an object of the present invention to provide a medium storage device, position demodulation device and position demodulation method for expanding the demodulation range by a phase servo signal.

It is another object of the present invention to provide a medium storage device, position demodulation device and position demodulation method for expanding the demodulation range by a phase servo signal, and decreasing the occurrence of seek errors even if a wind disturbance, temperature change and power supply voltage change occurs.

It is still another object of the present invention to provide a medium storage device, position demodulation device and position demodulation method for expanding the demodulation range by a phase servo signal, and preventing a drop in track accuracy.

To achieve these objects, a medium storage device of the present invention has: a storage medium where four servo pattern areas, on which at least four phase patterns having phases that are different between adjacent tracks are formed, are formed on each of a plurality of tracks; a head for at least reading data on the track of the storage medium; an actuator for moving the head in a crossing direction of the track of the storage medium; and a control unit for detecting a current position of the head from a phase difference of the regeneration signals in the four servo pattern areas, driving the actuator according to the detected current position and moving the head to a target track. And the four phase patterns of the storage medium are constituted by the first and second phase patterns of which phases are the same, and a third and fourth phase patterns of which phases are the opposite of the first and second phase patterns and of which phases are different from each other, the control unit demodulates position information in a first track range based on a first phase difference of the regeneration signals of the first and second servo pattern areas and of the third servo pattern area, demodulates position information in a second track range based on a second phase difference of the regeneration signal of the third servo pattern area and the fourth servo pattern area, and demodulates position information in a third track range based on the first phase difference according to an angle difference between the first phase difference and the phase of the regeneration signal in the third servo pattern area.

A position demodulation device of the present invention is a position demodulation device for demodulating a current position of a head from a phase difference of the regeneration signals in four servo pattern areas read by the head from a storage medium where the four servo pattern areas, on which at least four phase patterns having phases that are different between adjacent tracks are formed, are formed on each of a plurality of tracks, having: a phase demodulation circuit for demodulating the phases of the regeneration signals in the four servo pattern areas constituted by first and second phase patterns of which phases are the same, and a third and fourth phase patterns of which phases are the opposite of the first and second phase patterns and of which phases are different from each other; and a position demodulator for demodulating position information in a first track range based on a first phase difference of the regeneration signals of the first and second servo patterns areas and of the third servo pattern area, demodulating position information in a second track range based on a second phase difference of the regeneration signals in the third servo pattern area and the fourth servo pattern area, and demodulating position information in a third track range based on the first phase difference according to an angle difference between the first phase difference and a phase of the regeneration signal in the third servo pattern area.

A position demodulation method of the present invention is a position demodulation method for demodulating a current position of a head from a phase difference of the regeneration signals in four servo pattern areas read by the head from a storage medium where the four servo pattern areas, on which at least four phase patterns having phases being different between adjacent tracks are formed, are formed on each of a plurality of tracks, having: a phase demodulation step of demodulating the phases of the regeneration signals in the four servo pattern areas constituted by a first and second phase patterns of which phases are the same and a third and fourth phase pattern patterns of which phases are the opposite of the first and second phases and of which phases are different from each other; a first position demodulation step of demodulating position information in a first track range based on a first phase difference of the regeneration signals of the first and second servo pattern areas and of the third servo pattern area; a second position demodulation step of demodulating position information in a second track range based on a second phase difference of the regeneration signals in the third servo pattern area and the fourth servo pattern area; and a third position demodulation step of demodulating position information in a third track range based on the first phase difference according to an angle difference between the first phase difference and a phase of the regeneration signal in the third servo pattern area.

In the present invention, it is preferable that the phase difference between tracks in the first and second servo pattern areas is +90°, the phase difference between tracks in the third servo pattern area is −90°, and the phase difference between tracks in the fourth servo pattern area is −112.5°.

In the present invention, it is also preferable that the first track range is a ±1 track range, the second track range is a ±8 track range, and the third track range is a ±2 track range.

In the present invention, it is also preferable that the control unit demodulates the position information in the third track range from half of the first phase difference if the angle difference is −90° or more and less than +90°, and demodulates the position information in the third track range based on the angle obtained by adding 180° to half of the first phase difference if the angle difference is less than −90° and +90° or more.

In the present invention, it is also preferable that the control unit creates a target position trajectory according to a seek distance, generates a feed forward current according to the target position trajectory and feedback current according to a position error between the target position trajectory and the demodulation position, and drives the actuator by the sum of the feed forward current and the feedback current.

In the present invention, it is also preferable that the control unit detects the current position using the demodulation position in the second track range and the demodulation position in the third track range.

In the present invention, it is also preferable that the control unit converts an accuracy of the demodulation position in the second track range into that of the demodulation position in the third track range using the demodulation position in the third track range.

In the present invention, it is also preferable that the control unit masks the difference between the demodulation position in the third track range and the demodulation position in the second track range with the third track range, and converts an accuracy of the demodulation position in the second track range into that of the demodulation position in the third track range using the mask result.

In the present invention, it is also preferable that the control unit has a demodulation circuit for demodulating a regeneration waveform of the head by PLL synchronization using a preamble section of the servo pattern area.

Out of the four servo pattern areas constituted by the first and second phase patterns which have a same phase, and the third and fourth phase patterns which are the opposite phase of the first and second phase patterns and have difference phases from each other, the position information in the first track range is demodulated based on the first phase difference of the regeneration signals in the first and second servo pattern areas and the third servo pattern area, the position information in the second track range is demodulated based on the second phase difference of the regeneration signals in the third servo pattern area and the fourth servo pattern area, and the position information in the third track range is demodulated based on the first phase difference according to the angle difference between the first phase difference and the phase of the regeneration signal in the third servo pattern area, so the demodulation range in the second track range can be expanded using the phase in the third servo pattern area which is an absolute angle of which error is decreased. Therefore seek errors become less, and the accuracy of demodulation in the third track range is the same as the prior art since the first track range, which is a relative value, is used, and the on-track quality is not affected.

### BRIEF DESCRIPTION OF THE DRAWINGS

FIG. 1 is a diagram depicting a phase servo pattern according to an embodiment of the present invention;

FIG. 2 is a table describing a demodulation method for the phase servo pattern in FIG. 1;

FIG. 3 is a table showing a relationship between the angle of the phase servo pattern in FIG. 1 and the demodulation result in FIG. 2;

FIG. 4 is a diagram depicting a relationship between the angle of the phase servo pattern in FIG. 1 and the ±1 cylinder demodulation in FIG. 2 and the ±2 cylinder demodulation in FIG. 2;

FIG. 5 is a diagram depicting a relationship of the angle of the phase servo pattern in FIG. 1 and the ±8 cylinder demodulation in FIG. 2;

FIG. 6 is a block diagram depicting a medium storage device according to an embodiment of the present invention;

FIG. 7 is a diagram depicting the servo control section in FIG. 6;

FIG. 8 is a block diagram depicting the position demodulation system in FIG. 6;

FIG. 9 is a diagram depicting the position demodulation operation in FIG. 8;

FIG. 10 is a diagram depicting a configuration of a conventional disk having a servo pattern;

FIG. 11 is a diagram depicting a conventional phase servo pattern;

FIG. 12 is a diagram depicting a relationship of the angle of a phase servo pattern and the ±1 cylinder demodulation according to the prior art;

FIG. 13 is a diagram depicting a relationship of the angle of the phase servo pattern and the ±4 cylinder demodulation according to the prior art; and

FIG. 14 is a table showing a relationship between the angle of the phase servo pattern and a demodulation result according to the prior art.

### DESCRIPTION OF THE PREFERRED EMBODIMENTS

Embodiments of the present invention will now be described in the sequence of position demodulation method, medium storage device, and other embodiments, but the present invention is not limited to these embodiments.

### Position Demodulation Method

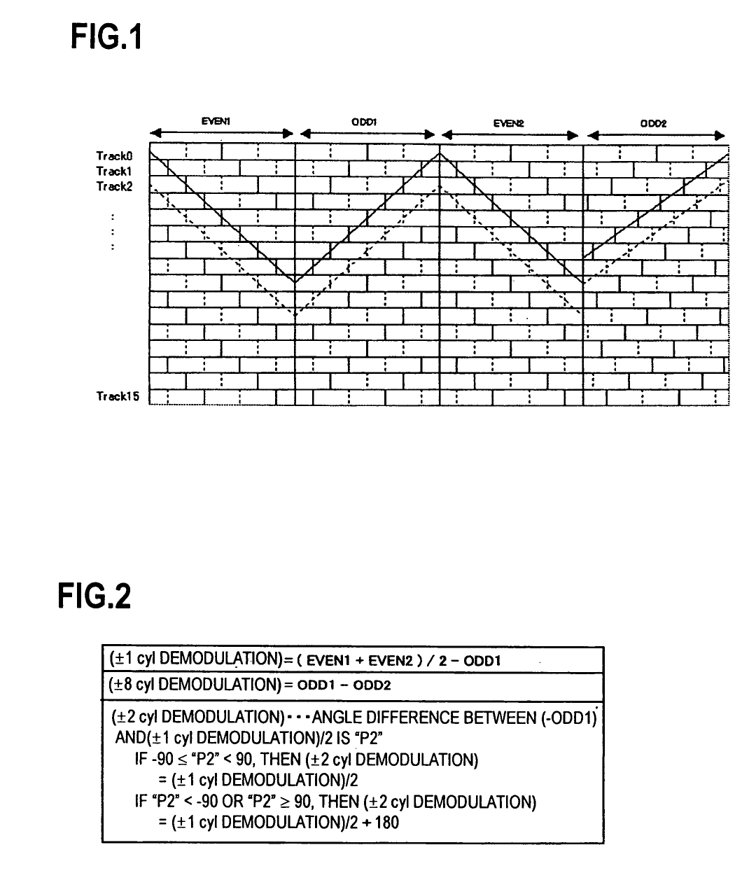

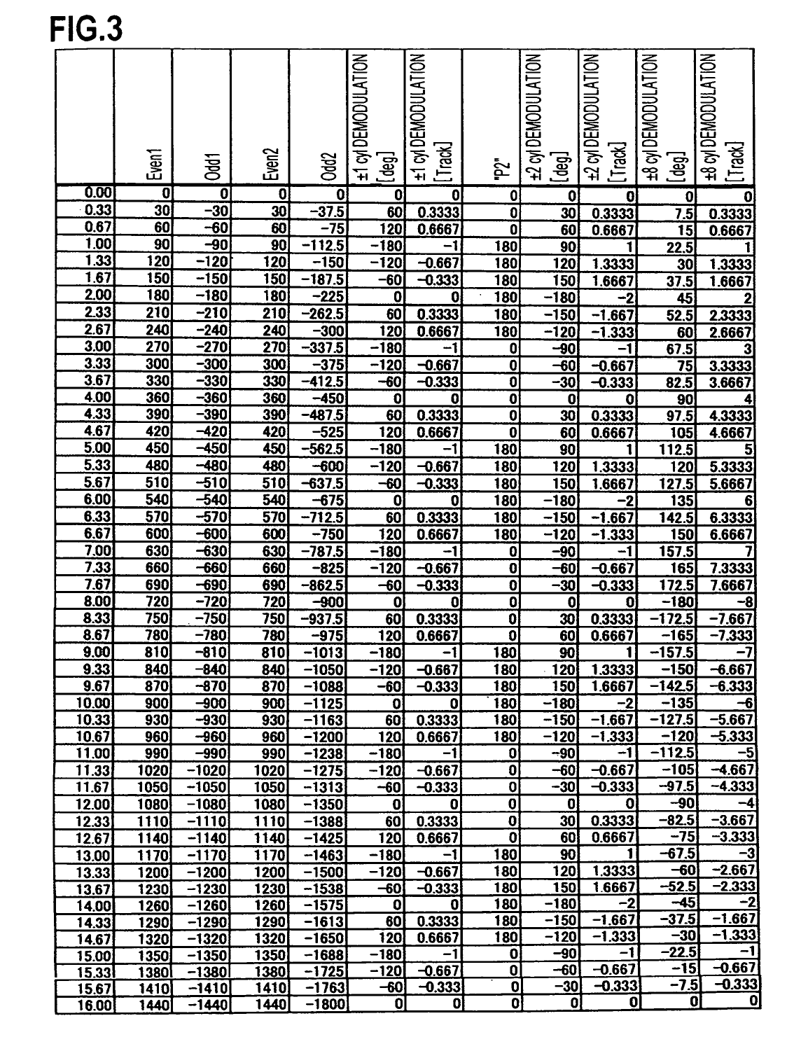

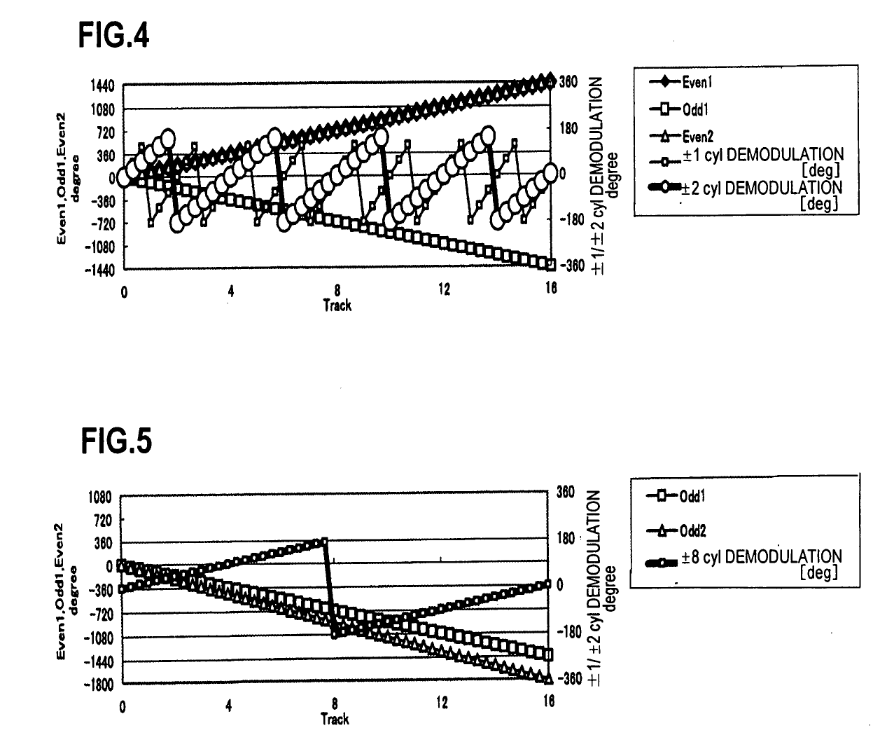

FIG. 1 is a diagram depicting a phase servo pattern of an embodiment of the present invention, FIG. 2 is a table describing the demodulation method for the phase servo pattern in FIG. 1, FIG. 3 is a table showing the relationship of the track position of the phase servo pattern in FIG. 1, the detection angles of EVEN1, EVEN2, ODD1 and ODD2 and the ±1 demodulation (angle, track position), ±2 demodulation (angle, track position) and ±8 demodulation (angle, track position), FIG. 4 is a diagram depicting the relationship of the track position, detection angles of EVEN1, EVEN2 and ODD1, and the ±1 demodulation (angle, track position) and ±2 demodulation (angle, track position), and FIG. 5 is a diagram depicting the relationship of the track position of the phase servo pattern in FIG. 1, detection angles of ODD1 and ODD2, and ±8 demodulation (angle, track position).

As FIG. 1 shows, the phase servo pattern is a four phase pattern, EVEN1, EVEN2 ODD1 and ODD2, and the length of the pattern is the same as the prior art. The feed angles of EVEN1, EVEN2 and ODD1 patterns are ±90°, ±90° and −90° respectively, just like the prior art, but the feed angle of the ODD2 pattern is −112.5°, while that of the prior art is −135°.

By changing the feed angle of the ODD2 pattern from the conventional −135° (=90°+45°) to −112.5° (=90+22.5°), a demodulation range double that of the prior art are acquired when the differential method (Expression (2)) is used. However, even if the feed angle is changed, the demodulation accuracy deteriorates depending on the accuracy of the detection angle. The demodulation method is also changed to prevent this.

FIG. 2 is a table describing the demodulation methods of the phase servo pattern in FIG. 1. As FIG. 2 shows, the expression of ±1 cylinder demodulation is the same as Expression (1) in the prior art, where the average value of the angles of EVEN1 and EVEN2 is used, and the feed angle difference is large, therefore accuracy is high.

By the above mentioned difference between the angle of ODD1 and the angle of ODD2, the value of ±8 cylinder demodulation is acquired using the following Expression (3).

### [Expression 3]

(±8 cyl demodulation)=ODD1−ODD2 (3)

In the present embodiment, ±2 cylinder demodulation is performed. If the difference between the ODD1 and (±1 cylinder demodulation)/2 (that is (±1 cylinder demodulation)/2−ODD1) is defined as “P2” here, then the ±2 cylinder demodulation value is determined by the following Expressions (4) and (5) according to the angle of “P2”.

$$\begin{matrix}[ Expression 4 ] & \\ ( \pm 2 cyl demodulation ) = ( \pm 1 cyl demodulation ) / 2 \\ ( when - 90 \leq P 2 < 90 ) & ( 4 ) \\ [ Expression 5 ] & \\ ( \pm 2 cyl demodulation ) = ( \pm 1 cyl demodulation ) / 2 + 180 \\ ( when P 2 < - 90 or P 2 \geq 90 ) & ( 5 )\end{matrix}$$

In other words, as FIG. 3 shows, the angle of the ±1 cylinder demodulation, which is a relative angle difference between the opposite phases EVEN1, EVEN2 and ODD1, rotates in 2 cylinder units. This means that the angle difference is repeated. The angle of ODD1, on the other hand, rotates in 4 cylinder units. Therefore when the angle of ODD1 is used, ±1 cylinder demodulation can be expanded to ±2 cylinder demodulation.

First, in order to convert the ±1 cylinder demodulation angle into 4 cylinder units, (±1 cylinder demodulation)/2 is calculated. The angle difference P2, between this ±1 cylinder demodulation angle converted into 4 cylinder units and the angle of ODD1 into 4 cylinder units is determined, and if this angle difference P2 is −90°≦P2<90°, the ±2 cylinder demodulation angle is acquired by half of the ±1 cylinder demodulation angle. If the angle difference P2 is −90°>P or P2≧90°, on the other hand, the ±2 cylinder demodulation angle is acquired by adding 180° to half of the ±1 cylinder demodulation angle.

In this way, the accuracy of ±2 cylinder demodulation is the same as conventional ±1 cylinder demodulation, and the demodulation range thereof is double that of conventional ±1 cylinder demodulation. Therefore even if ±8 cylinder demodulation having a double range is implemented by ±4 cylinder demodulation, of which accuracy is not very high, using the phase of ODD2 in FIG. 1, a drop in accuracy can be prevented if ±2 cylinder demodulation is used together.

The accuracy of ±2 cylinder demodulation will be described. In conventional demodulation, ±1 cylinder demodulation, which is the minimum unit, is calculated using the relative difference between EVEN1/2 and ODD1. However in an actual servo pattern, repeat continues in 4 cylinder units for both EVEN1/2 and ODD1, but the demodulation range with high accuracy is 2 cylinder units. This is because the relative difference of phases is used, which is theoretically unavoidable.

The reason why this relative difference must be used is that the probability of the rotation fluctuation of the spindle motor, writing position errors of the servo patterns in the circumference direction, and the servo mark detection jitters (asynchronous detection) in the read channel, becoming a cause of absolute angle errors, is high.

However, the influence of the rotation fluctuation of the spindle motor and the errors of the servo patterns in the circumference direction decreases if the read channel PLL-synchronizes with the signal read from the medium by the preamble portion of the servo section, and also if the servo mark detection method is a synchronization method, then detection jitters decrease and errors of the absolute angle also decrease.

Therefore in the present embodiment, the demodulation range is expanded using the absolute angle (ODD1 for P2 calculation) of which error is less. This decreases the seek errors. Although the demodulation range expands, the accuracy of ±2 cylinder demodulation is still the same as the prior art, since the ±1 cylinder demodulation angle, which is a relative value, is used, and on-track quality is not affected.

As FIG. 4 shows, as the angles of EVEN1/2 and ODD1 change in a 0 to 360° range, the angle and the track position of ±1 cylinder demodulation, and the angle and the track position of ±2 cylinder demodulation also change. The accuracy of these demodulation angles is high, since relative values are used.

Also as FIG. 5 shows, as the angles of ODD1 and ODD2 change in a 0° to 360° range, the angle and the track position of ±8 cylinder demodulation also change. Although relative values of the feed angles of ODD1 and ODD2 are used, this demodulation accuracy is lower than the prior art, since these feed angles are closer together than the prior art. In other words, the demodulation accuracy changes easily if the rotation fluctuation and a slight displacement of the servo pattern occurs.

Therefore in the present embodiment, the angle and the track position of ±2 cylinder demodulation are acquired from the ±1 cylinder demodulation angle acquired from relative values using an absolute value of ODD1, and the demodulation range is expanded by using the ±2 cylinder demodulation together with ±8 cylinder demodulation to prevent a drop in accuracy.

### Medium Storage Device

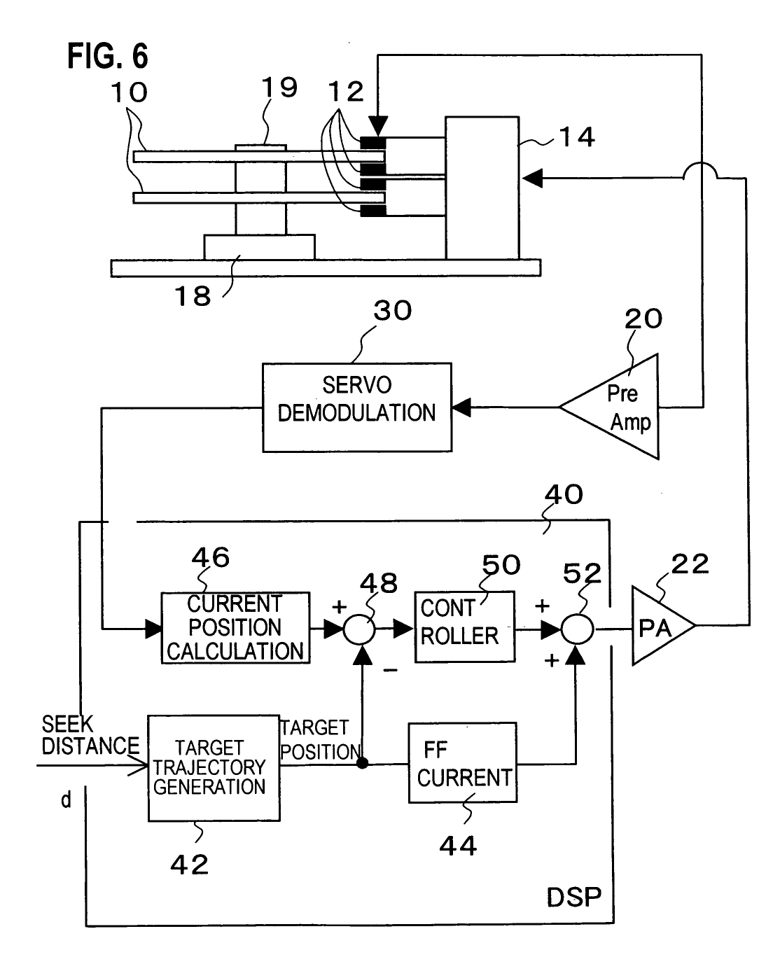

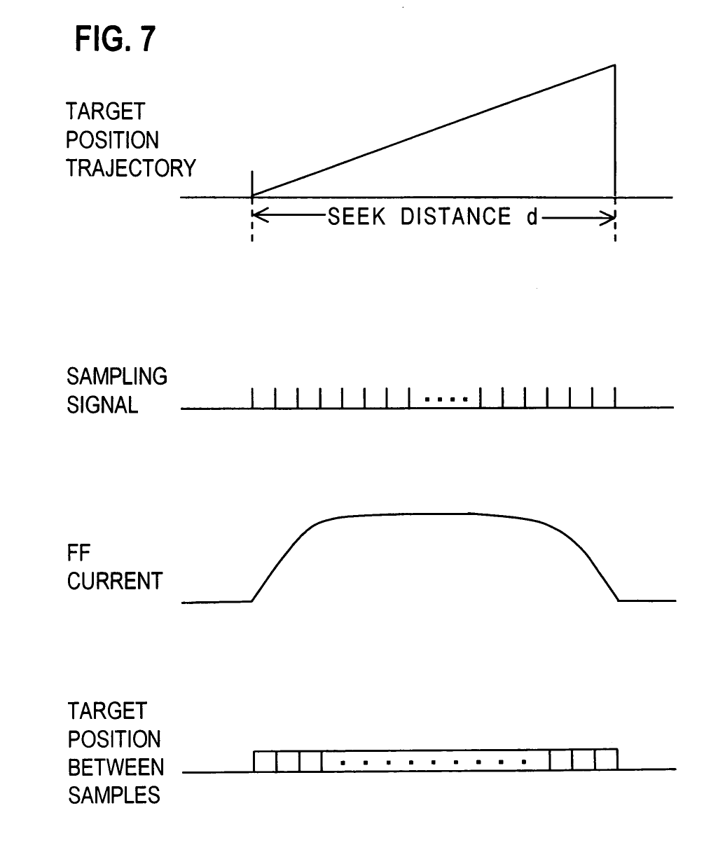

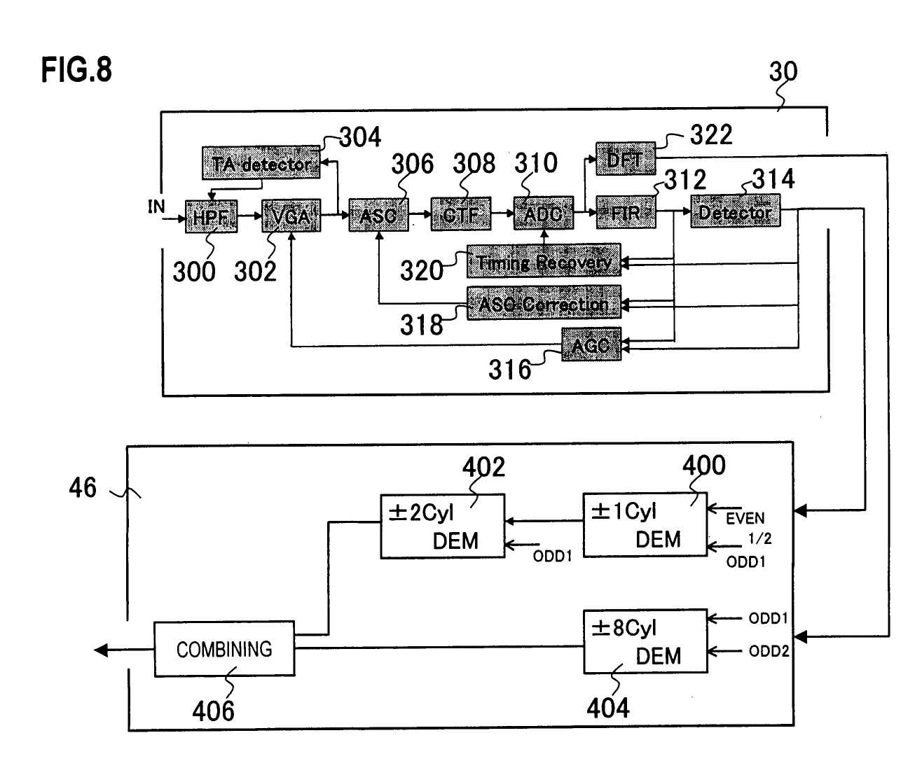

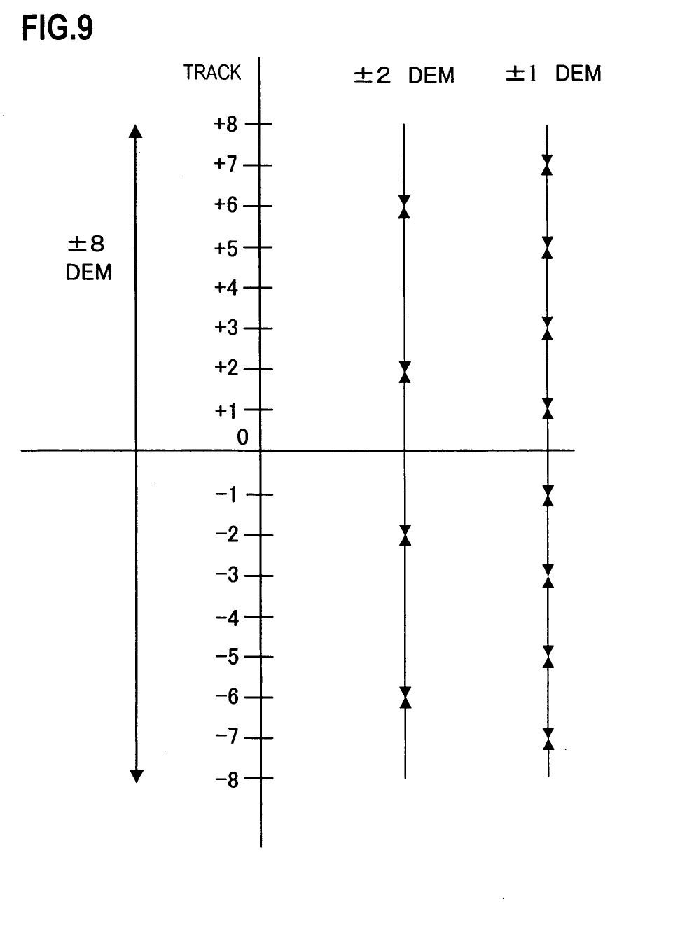

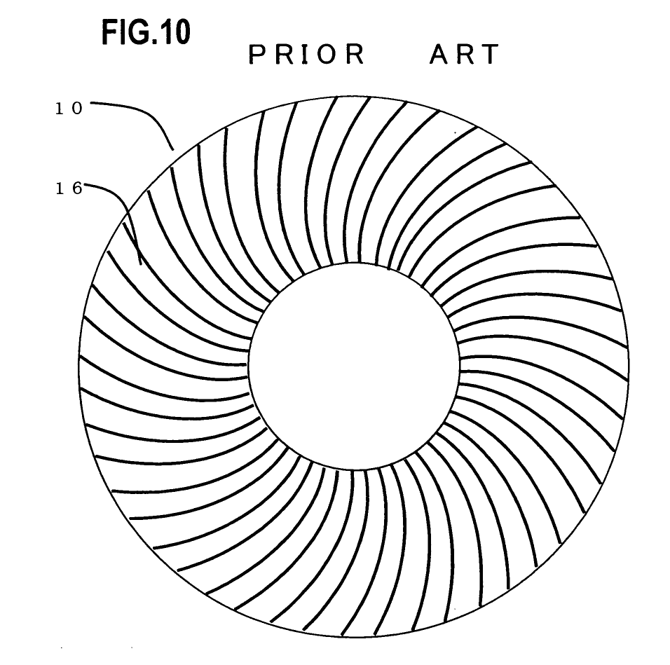

FIG. 6 is a block diagram depicting a medium storage device according to an embodiment of the present invention, FIG. 7 is a diagram depicting the seek control in FIG. 6, FIG. 8 is a block diagram depicting the demodulation system in FIG. 6, and FIG. 9 is a diagram depicting the operation of the demodulation system in FIG. 6.

FIG. 6 shows a magnetic disk device as a medium storage device. As FIG. 6 shows, magnetic disks 10, which are magnetic storage media, are installed at a rotation axis 19 of a spindle motor 18. The spindle motor 18 rotates the magnetic disk 10. An actuator (VCM) 14 has magnetic heads 12 at the tip, and moves the magnetic heads 12 in a radius direction of the magnetic disk 10.

The actuator 14 is constituted by a voice coil motor (VCM) which rotates on the rotation axis. In FIG. 6, two magnetic disks 10 are installed in the magnetic disk device, and four magnetic heads 12 are simultaneously driven by the same actuator 14.

The magnetic head 12 is constituted by read elements and write elements. In the magnetic head 12, read elements including magneto-resistance (MR) elements are stacked on a slider, and write elements including a write coil are stacked thereon.

A position signal (analog signal) read by the magnetic head 12 is amplified by a preamplifier 20, and is then input to a servo demodulation circuit 30. The servo demodulation circuit 30 synchronously detects a servo mark, as described in FIG. 8, and demodulates an angle (vector information) of each phase pattern of the servo signal.

The demodulation angle is input to a data processing unit (digital signal processor) 40. The data processing unit 40 executes data processing of a feedback control system having a feed forward (FF) function.

This control system will now be described with reference to FIG. 7. A target trajectory generation section 42 generates a target position trajectory for each sample from the start of seek according to a seek distance “d”, and determines a velocity curve based on this position trajectory, and generates a target position for each sample.

An FF (Feed Forward) current generation section 44 generates a feed forward (FF) current which follows a velocity curve to the target position according to the target position trajectory. A current position calculation section 46 executes ±1 cylinder demodulation, ±2 cylinder demodulation and ±8 cylinder demodulation based on the angle information of the four phase patterns from the servo demodulation circuit 30, and calculates the current position.

A position error calculation section 48 subtracts the target position from the current position to calculate a position error (for each sample). A controller 50 calculates feedback current to eliminate the position error by observer control and PID control. A current addition section 52 adds the FF current of the FF current generation section 44 and the feedback current of the controller 50, to generate VCM control current. A power amplifier 22 amplifies the VCM control current and drives the VCM 14.

In other words, a feed forward current for the target trajectory is supplied for each sample, and an error from the target trajectory is acquired by the error between the samples of the target trajectory and the demodulation position, and is corrected by the feedback controller 50.

Now the servo demodulation system will be described with reference to FIG. 8 and FIG. 9. As FIG. 8 shows, in the servo demodulation circuit 30, a read signal from the preamplifier 20 is input to a high pass filter (HPF) 300. The high pass filter 300 cuts the low frequency components (mainly DC components) of the read signal, and is output to a variable gain amplifier 302. The variable gain amplifier (VGA) 302 amplifies the output of the high pass filter 300 by a gain from a later mentioned AGC circuit 316.

The output of the variable gain amplifier 302 is input to a thermal asperity detection circuit (TA detector) 304. The thermal asperity detection circuit 304 detects thermal asperity from the output of the variable gain amplifier 302. The thermal asperity refers to phenomena where the characteristics of the read element (MR element) of the head change due to the heat generated when the head collides with the medium, and read output becomes abnormal. If the thermal asperity is detected, operation of the high pass filter 300 is stopped for a predetermined time.

The output of the variable gain amplifier 302 is input to an asymmetric characteristic control circuit (ASC) 306. The asymmetric characteristic control circuit 306 corrects the asymmetry between the upper and the lower of the output signal of the MR element of the magnetic head with a correction amount of an asymmetric characteristic correction circuit 318, and converts it into a symmetric signal between the upper and the lower. The signal output from the asymmetric characteristic control circuit 306 is input to a control filter (CTF) 308. The control filter 308 constitutes a pre-filter for shaping the signal waveform.

The output of the control filter 308 is input to an analog/digital converter (ADC) 310, where an analog signal is converted into a digital value at a sampling clock at which timing is synchronized. The output of the ADC 310 is input to a finite impulse response filter (FIR) 312 for shaping a PR (partial Response) signal.

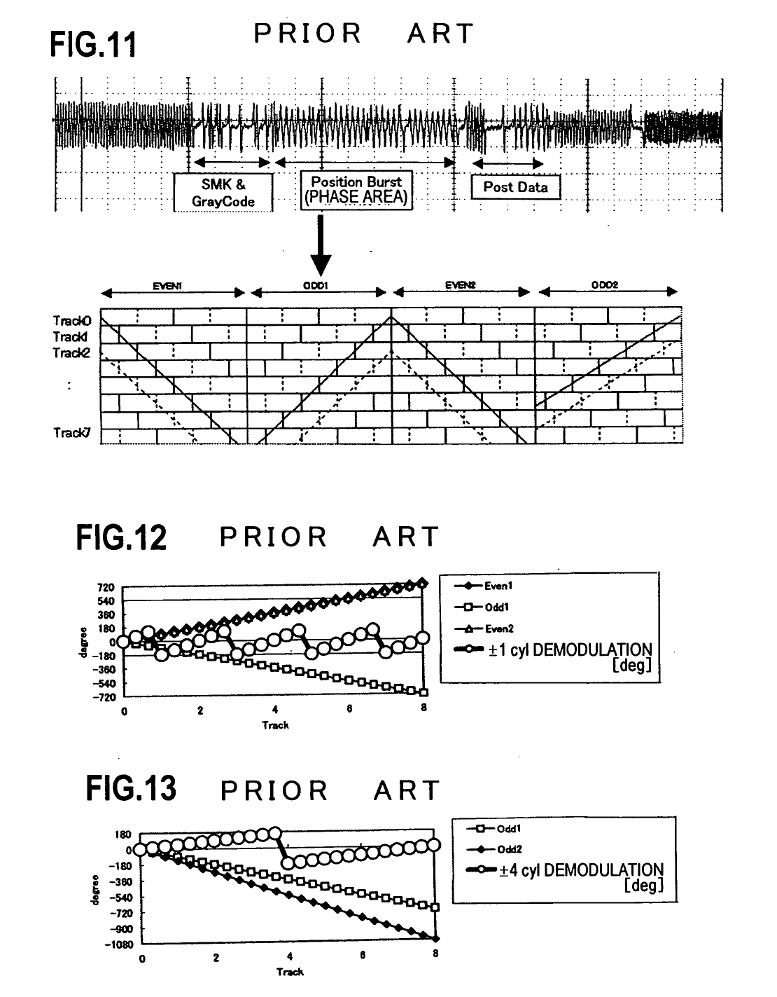

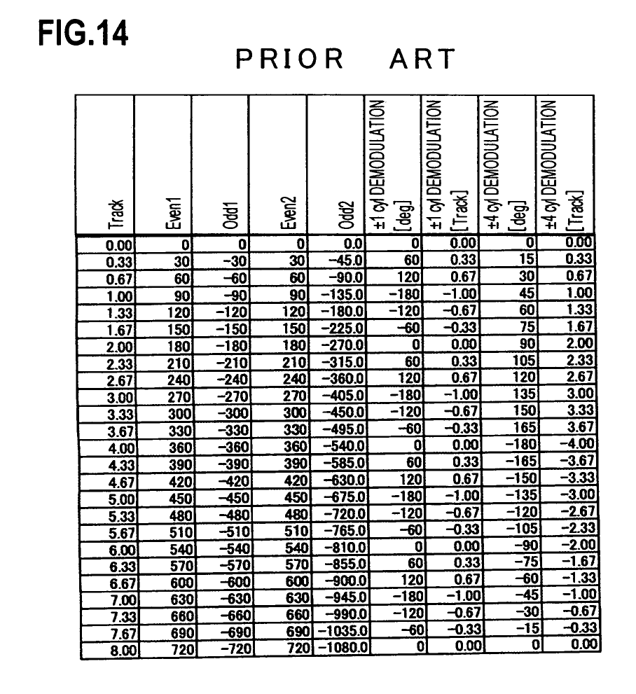

A servo mark detection circuit 314 detects a servo mark described in FIG. 11, from the output of the FIR 312. An AGC (Automatic Gain Control) 316 locks the control gain of the variable gain amplifier 302 based on the output of the FIR 312 and the servo mark detection output of the servo mark detection circuit 314.

The asymmetric characteristic correction circuit 318 locks the control gain of the variable gain amplifier 302 by the output of the FIR 312 and the servo mark detection output of the servo mark detection circuit 314. A timing recovery circuit 320 PLL-controls the clock of the ADC 310 by the output of the FIR 312 and the servo mark detection output of the servo mark detection circuit 314.

A digital Fourier transformer (DFT) 322 digital Fourier-transforms the output of the ADC 310 and calculates the angle information (vector information) of the above mentioned phase patterns.

This servo demodulation circuit 30 controls the timing recovery circuit 320 with servo marks, and performs PLL-synchronization so as to decrease the influence of the rotation fluctuation of the spindle motor and the position error of the servo pattern in the circumference direction. Also since servo mark detection is a synchronization type that the AGC 316 and the timing recovery circuit 320 are controlled by the servo mark detection, the detection jitter is less. Therefore error of the absolute angle is less, and this servo demodulation circuit 30 is suitable for the position demodulation of the present embodiment.

Now a current position calculation section 46 will be described. The angle information to be output from the DFT 322 is EVEN1/2 and ODD1/2. The ±1 cylinder demodulation section 400 calculates the ±1 cylinder demodulation angle using the above Expression (1), and from this angle, the demodulation position for each track is calculated, as described in the table in FIG. 3.

As described in FIG. 2, the ±2 cylinder demodulation section 402 calculates the angle difference P2, calculates Expression (4) or (5) depending on the value of the angle difference P2, calculates the ±2 cylinder demodulation angle, and as described in the table in FIG. 3, calculates the demodulation position for each track based on this angle.

The ±8 cylinder demodulation section 404 calculates the ±2 cylinder demodulation angle using the above Expression (2), and as described in the table in FIG. 3, calculates the demodulation position for each track on this angle.

FIG. 9 is a diagram depicting the relationship of the above mentioned ±1 cylinder demodulation position, ±2 cylinder demodulation position and ±8 cylinder demodulation position, and indicates the relationship of the ranges of each demodulation position.

A combining circuit 406 converts the accuracy of the ±8 cylinder demodulation position to that of the ±2 cylinder demodulation position. For this, the value of the ±8 cylinder demodulation position is converted into a DIFF value in the ±2 cylinder demodulation range using the following Expression (6).

### [Expression 6]

DIFF=((±2 cyl demodulation)−(±8 cyl demodulation)) AND ±2 cyl (6)

In Expression (6), AND ±2 cylinder indicates a mask of a ±2 cylinder, and Expression (6) shows an operation where ((±2 cylinder demodulation)−(±8 cylinder demodulation)) enters the range of the ±2 cylinder.

Specifically, if the value of ((±2 cylinder demodulation)−(±8 cylinder demodulation)) is ±2 cylinder or more, the value of 4 cylinder is subtracted from this value, and this operation is repeated until the value after subtraction becomes smaller than the value of ±2 cylinder. If the value of ((±2 cylinder demodulation)−(±8 cylinder demodulation)) is smaller than the value of −2 cylinder, the value of 4 cylinder is added to this value, and this operation is repeated until the added value becomes greater than the value of the −2 cylinder.

From the value DIFF converted into the ±2 cylinder demodulation range and the ±8 cylinder demodulation position, which is an original value, the combined ±8 cylinder demodulation position is calculated using the following Expression (7).

### [Expression 7]

(Combined ±8 cyl demodulation)=DIFF+(±8 cyl demodulation) (7)

In other words, the relationship between the ±8 cylinder demodulation range and the ±2 cylinder demodulation range is as shown in FIG. 9. Then the difference of the ±2 cylinder demodulation position and the ±8 cylinder demodulation position, acquired from the same position information, is masked with the ±2 cylinder demodulation range, and is converted into the DIFF value in the ±2 cylinder demodulation range. This is the difference of the accuracies of the ±8 cylinder demodulation position and the ±2 cylinder demodulation position. By adding this difference DIFF to the original ±8 cylinder demodulation position using Expression (7), the accuracy of the ±8 cylinder demodulation position can be converted into the accuracy of the ±2 cylinder demodulation.

In the configuration in FIG. 8, this combined demodulation position is used as a current position. In this case, this current position can be used both during seek control and during on-track. This combined demodulation position may be used for seek control, and the ±2 cylinder demodulation position may be used during on-track. The ±8 cylinder demodulation position may be used before a target track, and the ±2 cylinder demodulation position may be used near the target track during seek control, without using the combined demodulation position, and the ±1 cylinder demodulation position or the ±2 cylinder demodulation position may be used during on-track.

### Other Embodiments

In the above embodiments, the position demodulation was described using an example of head position demodulation of a magnetic disk device, but this can also be applied to other disk devices, such as an optical disk device. As mentioned above, creating a combined demodulation position is not always necessary, and the configuration is sufficient if the ±8 cylinder demodulation position and the ±2 cylinder demodulation position are both used. The feed angle of ODD2 is −112.5°, but this can be any value which does not exceed −90°.

The present invention was described with embodiments, but the present invention can be modified in various ways within the scope of the spirit of the invention, and these variant forms shall not be excluded from the scope of the present invention.

The position information in the first track range is demodulated based on the first phase difference of the regeneration signals in the first and second servo pattern areas and the third servo pattern area, the position information in the second track range is demodulated based on the second phase difference of the regeneration signals in the third servo pattern area and the fourth servo pattern area, and the position information in the third track range is demodulated based on the first phase difference according to the angle difference between the first phase difference and the phase of the regeneration signal in the third servo pattern area, so the demodulation range in the second track range can be expanded using the phase of the third servo pattern area, which is an absolute angle of which error is decreased. Therefore the seek errors become less, and the accuracy of demodulation in the third track range is the same as the prior art, since the first track range, which is a relative value, is used, and the on-track quality is not affected.

What is claimed is:

1. A medium storage device, comprising:
a storage medium where four servo pattern areas, on which at least four phase patterns having different phases between adjacent tracks are formed, are formed on each of a plurality of tracks;
a head for at least reading data on the track of the storage medium;
an actuator for moving the head in a crossing direction of the track of the storage medium; and
a control unit for detecting a current position of the head from a phase difference of regeneration signals in the four servo pattern areas, driving the actuator according to the detected current position and moving the head to a target track,
wherein the four phase patterns of the storage medium are constituted by a first and second phase patterns of which phases are the same, and a third and fourth phase patterns of which phases are the opposite of the first and second phase patterns and of which phases are different from each other,
and wherein the control unit demodulates position information in a first track range based on a first phase difference of the regeneration signals of first and second servo pattern areas and of third servo pattern area, demodulates position information in a second track range based on a second phase difference of the regeneration signals of the third servo pattern area and fourth servo pattern area, and demodulates position information in a third track range based on the first phase difference according to an angle difference between the first phase difference and the phase of the regeneration signal in the third servo pattern area.

2. The medium storage device according to claim 1, wherein the phase difference between tracks in the first and second servo pattern areas is +90°, the phase difference between tracks of the third servo pattern area is −90°, and the phase difference between tracks in the fourth servo pattern area is −112.5°.

3. The medium storage device according to claim 2, wherein the first track range is a ±1 track range, the second track range is a ±8 track range, and the third track range is a ±2 track range.

4. The medium storage device according to claim 1, wherein the control unit demodulates the position information in the third track range from half of the first phase difference when the angle difference is −90° or more and less than +90°, and demodulates the position information in the third track range based on the angle obtained by adding 180° to half of the phase difference when the angle difference is less than −90° and +90° or more.

5. The medium storage device according to claim 1, wherein the control unit creates a target position trajectory according to a seek distance, generates a feed forward current according to the target position trajectory and a feedback current according to a position error between the target position trajectory and the demodulation position, and drives the actuator by a sum of the feed forward current and the feedback current.

6. The medium storage device according to claim 1, wherein the control unit detects the current position using the demodulation position in the second track range and the demodulation position in the third track range.

7. The medium storage device according to claim 1, wherein the control unit converts an accuracy of the demodulation position in the second track range into the accuracy of the demodulation position in the third track range using the demodulation position in the third track range.

8. The medium storage device according to claim 7, wherein the control unit masks the difference between the demodulation position in the third track range and the demodulation position in the second track range with the third track range, and converts an accuracy of the demodulation position in the second track range into the accuracy of the demodulation position in the third track range using the mask result.

9. The medium storage device according to claim 1, wherein the control unit comprises a demodulation circuit for demodulating a regeneration waveform of the head by PLL synchronization using a preamble section of the servo pattern area.

10. A position demodulation device for demodulating a current position of a head from a phase difference of regeneration signals in four servo pattern areas read by the head from a storage medium where the four servo pattern areas, on which at least four phase patterns having different phases between adjacent tracks are formed, are formed on each of a plurality of tracks, comprising:
a phase demodulation circuit for demodulating phases of the regeneration signals in the four servo pattern areas constituted by first and second phase patterns of which phases are the same, and a third and fourth phase patterns of which phases are the opposite of the first and second phase patterns and of which phases are different from each other; and
a position demodulator for demodulating position information in a first track range based on a first phase difference of the regeneration signals of the first and second servo pattern areas and of the third servo pattern area, demodulating position information in a second track range based on a second phase difference of the regeneration signals in the third servo pattern area and the fourth servo pattern area, and demodulating position information in a third track range based on the first phase difference according to an angle difference between the first phase difference and a phase of the regeneration signal in the third servo pattern area.

11. The position demodulation device according to claim 10, wherein the phase difference between tracks in the first and second servo pattern area is +90°, the phase difference between tracks of the third servo pattern area is −90°, and the phase difference between tracks in the fourth servo pattern area is −112.5°.

12. The position demodulation device according to claim 11, wherein the first track range is a ±1 track range, the second track range is a ±8 track range, and the third track range is a ±2 track range.

13. The position demodulation device according to claim 10, wherein the position demodulator demodulates the position information in the third track range from half of the first phase difference when the angle difference is −90° or more and less than +90°, and demodulates the position information in the third track range from the angle obtained by adding 180° to half of the first phase difference when the angle difference is less than −90° and +90° or more.

14. The position demodulation device according to claim 10, wherein the position demodulator outputs the demodulation position in the second track range and the demodulation position in the third track range as the current position.

15. The position demodulation device according to claim 10, wherein the position demodulator converts an accuracy of the demodulation position in the second track range into the accuracy of the demodulation position in the third track range using the demodulation position in the third track range.

16. The position demodulation device according to claim 15, wherein the position demodulator masks a difference between the demodulation position in the third track range and the demodulation position in the second track range with the third track range, and converts an accuracy of the demodulation position in the second track range into that of the demodulation position in the third track range using the mask result.

17. The position demodulation device according to claim 10, wherein the phase demodulation circuit comprises a demodulation circuit for demodulating a regeneration waveform of the head by PLL synchronization using a preamble section of the servo pattern area.

18. A position demodulation method for demodulating a current position of a head from a phase difference of the regeneration signals in four servo pattern areas read by the head from a storage medium where the four servo pattern area, on which at least four phase patterns having different phases between adjacent tracks are formed, are formed on each of a plurality of tracks, comprising:
a phase demodulation step of demodulating phases of the regeneration signals in the four servo pattern areas constituted by a first and second phase patterns of which phases are the same and a third and fourth phase patterns of which phases are the opposite of the first and second phase patterns and of which phases are different from each other;
a first position demodulation step of demodulating position information in a first track range based on a first phase difference of the regeneration signals of the first and second servo pattern areas and of the third servo pattern area;
a second position demodulation step of demodulating position information in a second track range based on a second phase difference of regeneration signals in the third servo pattern area and the fourth servo pattern area; and
a third position demodulation step of demodulating position information in a third track range based on the first phase difference according to an angle difference between the first phase difference and a phase of the regeneration signal in the third servo pattern area.

19. The position demodulation method according to claim 18, wherein the phase difference between tracks in the first and second servo pattern areas is +90°, the phase difference between tracks of the third servo pattern area is −90°, and the phase difference between tracks in the fourth servo pattern area is −112.5°.

20. The position demodulation method according to claim 19, wherein the first track range is a ±1 track range, the second track range is a ±8 track range, and the third track range is a ±2 track range.
